(19) United States
(12) Patent Application Publication
(10) Pub. No.: US 2023/0046915 A1
(43) Pub. Date: Feb. 16, 2023

(54) ANONYMIZATION APPARATUS, ANONYMIZATION METHOD, AND COMPUTER READABLE MEDIUM

(71) Applicant: Mitsubishi Electric Corporation, Tokyo (JP)

(72) Inventors: Mitsuhiro HATTORI, Tokyo (JP); Takashi ITO, Tokyo (JP); Nori MATSUDA, Tokyo (JP)

(73) Assignee: Mitsubishi Electric Corporation, Tokyo (JP)

(21) Appl. No.: 17/978,669

(22) Filed: Nov. 1, 2022

Related U.S. Application Data
(63) Continuation of application No. PCT/JP2020/025096, filed on Jun. 25, 2020.

(51) Int. Cl. G06F 21/62

(52) U.S. Cl. CPC G06F 21/6254

(57) ABSTRACT

An anonymization apparatus (100) includes an anonymization unit (120), a plurality of attack units (131), a degree of safety calculation unit (133), and a parameter adjustment unit (140). The anonymization unit (120) generates anonymized data. Each of the plurality of attack units (131) generates re-identification data that corresponds to the anonymized data using a re-identification attack algorithm that differs from each other. The degree of safety calculation unit (133) calculates a degree of safety of each piece of the re-identification data that each of the plurality of attack units (131) generated. The parameter adjustment unit (140) adjusts an anonymization parameter in a case where at least one of the degrees of safety does not satisfy a degree of safety standard.

### CROSS REFERENCE TO RELATED APPLICATION

This application is a Continuation of PCT International Application No. PCT/JP2020/025096, filed on Jun. 25, 2020, which is hereby expressly incorporated by reference into the present application.

### TECHNICAL FIELD

The present disclosure relates to an anonymization apparatus, an anonymization method, and an anonymization program.

### BACKGROUND ART

Anonymization technology that converts personal data into anonymized data is known as technology for seeking balance between protection and utilization of personal data. The personal data can be converted into the anonymized data with the anonymization technology. In a case where the anonymized data is used instead of the personal data, utilization such as providing a third party with information similar to the personal data, using information similar to the personal data for an unintended purpose, or the like will be possible while protecting rights and interests of an individual. As a specific example, a case in which a business operator who owns a piece of personal data (hereinafter called provider) providing a business operator who does not own the personal data (hereinafter called recipient) with the personal data will be considered. In this case, there is a risk of the rights and interests of an individual being infringed in a case where the provider provides the recipient with the personal data as is. In a case where the provider converts the personal data into anonymized data and provides the recipient with the anonymized data, however, the recipient can utilize information that includes information of an individual while protecting rights and interests of the individual.

An attack that re-identifies a part or all of original personal data from the anonymized data (hereinafter called re-identification attack) is known as a threat to the anonymized data. There are various techniques to such a re-identification attack, and there are also various techniques to the anonymization method that counter the re-identification attack.

The provider who performs anonymization, however, cannot know precisely in advance the re-identification attack that the recipient will perform. Therefore, technology for selecting an anonymization method such that the anonymized data is safe against a specific re-identification attack is proposed to increase safety of the anonymized data even slightly.

### CITATION LIST

### Patent Literature

Patent Literature 1: JP 2017-076170 A

### SUMMARY OF INVENTION

### Technical Problem

Patent Literature 1 discloses technology that, in a case where a provider has a safety standard set, uses a re-identification attack algorithm that is modeled simulating an actual attacker, and accurately outputs a combination of an attribute that satisfies this standard and an anonymization level. The present technology, however, takes only a case of one re-identification attack algorithm into consideration. Consequently, there is an issue where the present technology cannot guarantee satisfying safety against a different re-identification attack algorithm.

The present disclosure aims to guarantee satisfying safety of anonymized data against a plurality of re-identification attack algorithms.

### Solution to Problem

An anonymization apparatus according to the present disclosure includes:

an anonymization unit to generate anonymized data, the anonymized data being personal data that is anonymized, by anonymizing the personal data using an anonymization algorithm, the anonymization algorithm being an algorithm that anonymizes the personal data and that uses an anonymization parameter;

a plurality of attack units to generate a plurality of pieces of re-identification data, the re-identification data being information that corresponds to the anonymized data and that corresponds to each of a plurality of re-identification attack algorithms, by performing a re-identification attack on the anonymized data using the plurality of re-identification attack algorithms that execute the re-identification attack that tries to re-identify at least a part of the personal data from the anonymized data;

a degree of safety calculation unit to calculate a plurality of degrees of safety that indicate safety of the anonymized data using the personal data and each of the plurality of pieces of re-identification data, and that correspond to each of the plurality of pieces of re-identification data; and

a parameter adjustment unit to adjust the anonymization parameter in a case where at least one of the plurality of degrees of safety does not satisfy a degree of safety standard that indicates a standard of safety of the anonymized data, wherein

the number of each of the plurality of re-identification attack algorithms, the plurality of pieces of re-identification data, and the plurality of attack units is a same,

each of the plurality of re-identification attack algorithms differs from each other and corresponds to any one of the plurality of pieces of re-identification data that differs from each other,

each of the plurality of attack units generates any one of the plurality of pieces of re-identification data using any one of the plurality of re-identification attack algorithms that differs from each other, and

each of the plurality of pieces of re-identification data corresponds to any one of the plurality of degrees of safety that differs from each other.

### Advantageous Effects of Invention

The anonymization apparatus according to the present disclosure includes an anonymization unit, a plurality of attack units, a degree of safety calculation unit, and a parameter adjustment unit. The anonymization unit generates anonymized data. Each of the plurality of attack units uses a re-identification attack algorithm that differs from each other to generate re-identification data that corresponds to the anonymized data. The degree of safety calculation unit calculates a degree of safety of each piece of the re-identification data that each of the plurality of attack units generated. The parameter adjustment unit adjusts an anonymization parameter in a case where at least one of the degrees of safety does not satisfy a degree of safety standard. The anonymization parameter is used in the re-identification attack algorithm.

Thus, according to the present disclosure, satisfying safety of anonymized data against a plurality of re-identification attack algorithms can be guaranteed.

### BRIEF DESCRIPTION OF DRAWINGS

FIG. 1 is an example of a functional configuration of an anonymization apparatus 100 according to Embodiment 1.

FIG. 2 is an example of a hardware configuration of the anonymization apparatus 100 according to Embodiment 1.

FIG. 3 is a flowchart illustrating an example of operation of the anonymization apparatus 100 according to Embodiment 1.

FIG. 4 is a diagram that visualized an example of personal data according to Embodiment 1.

FIG. 5 is a table illustrating examples of the personal data and anonymized data according to Embodiment 1.

FIG. 6 is an example of initial parameters according to Embodiment 1.

FIG. 7 is an example of processing results of attack attempting units 130 according to Embodiment 1.

FIG. 8 is an example of new parameters according to Embodiment 1.

FIG. 9 is a diagram that visualized an example of the anonymized data according to Embodiment 1.

FIG. 10 is an example of a hardware configuration of an anonymization apparatus 100 according to a variation of Embodiment 1.

FIG. 11 is an example of personal data according to Embodiment 2.

FIG. 12 is an example of the personal data and anonymized data according to Embodiment 2.

FIG. 13 is a probability density function corresponding to an example of an initial parameter according to Embodiment 2.

FIG. 14 is an example of the anonymized data and re-identification data according to Embodiment 2.

FIG. 15 is an example of a functional configuration of an anonymization apparatus 100 according to Embodiment 3.

FIG. 16 is an example of intermediate processing data and anonymized data according to Embodiment 3.

FIG. 17 is an example of a functional configuration of an anonymization apparatus 100 according to a variation of Embodiment 3.

FIG. 18 is an example of a functional configuration of an anonymization apparatus 100 according to Embodiment 4.

FIG. 19 is an example of processing amount parameter tables according to Embodiment 4.

FIG. 20 is an example of initial parameters according to Embodiment 4.

### DESCRIPTION OF EMBODIMENTS

In the description and in the drawings of the embodiments, the same reference signs are added to the same elements and corresponding elements. Description of elements having the same reference signs added will be suitably omitted or simplified. Arrows in the drawings mainly indicate flows of data or flows of processes.

### Embodiment 1

In the following, the present embodiment will be described in detail while referring to the drawings.

In the description below, a provider is a business operator and the like that owns personal data. A recipient is a business operator and the like that does not own the personal data. The personal data includes information relating to an individual and information that can identify a specific individual. At least one of the provider and the recipient does not have to be an entity or the like, and may be a computer and the like.

### Description of Configuration

In the description of the present embodiment, as a specific example, a case where there is only one anonymization method will be described. The present example corresponds to a most basic configuration of an anonymization apparatus 100.

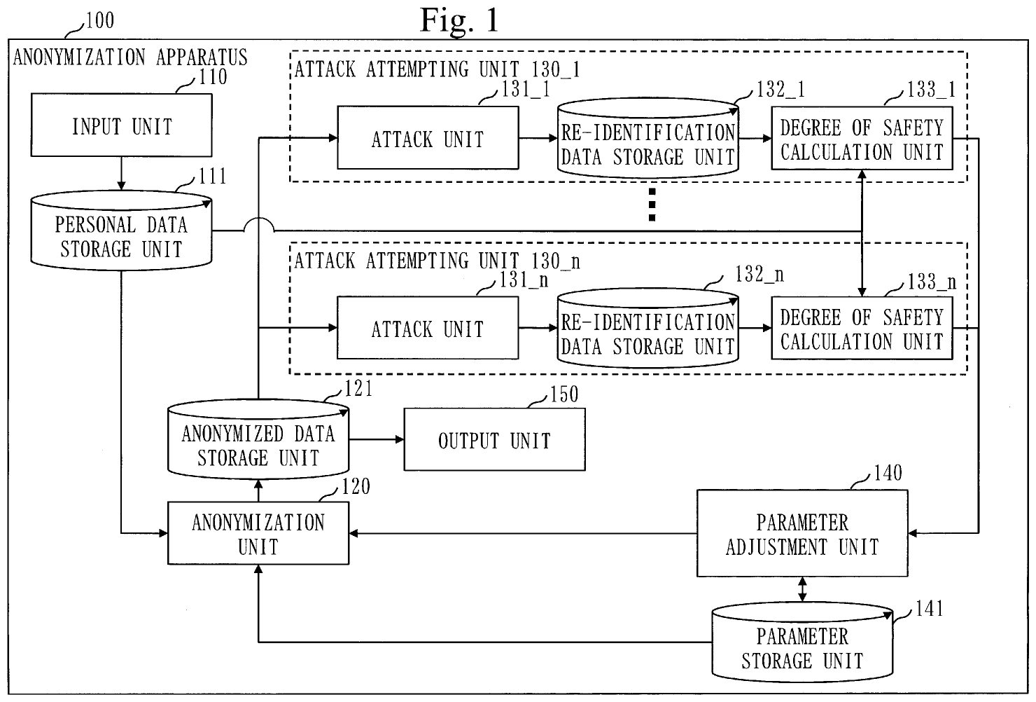

FIG. 1 illustrates an example of a functional configuration of the anonymization apparatus 100 of the present embodiment.

The anonymization apparatus 100 is an apparatus that generates anonymized data from the personal data. The anonymized data is the personal data that is anonymized. As illustrated in the present drawing, the anonymization apparatus 100 is configured of a plurality of elements.

An input unit 110 is an element for a person in charge, who is not illustrated, belonging to the provider to input the personal data.

A personal data storage unit 111 is an element that stores the personal data inputted to the anonymization apparatus 100.

An anonymization unit 120 is an element that generates the anonymized data from the personal data based on an anonymization parameter. The anonymization parameter is a parameter that is used when generating the anonymized data. The anonymization unit 120 generates the anonymized data by anonymizing the personal data using an anonymization algorithm. The anonymization algorithm is an algorithm that anonymizes the personal data and is an algorithm that uses the anonymization parameter.

The anonymization unit 120 may anonymize the personal data according to a property of the personal data.

An anonymized data storage unit 121 is an element that stores the anonymized data that the anonymization unit 120 generated.

An attack attempting unit 130 is a group of elements that calculates a degree of safety by executing a re-identification attack algorithm. The re-identification attack algorithm is an algorithm that executes a re-identification attack. One attack attempting unit 130 uses one re-identification attack algorithm. The attack attempting unit 130 includes an attack unit 131, a re-identification data storage unit 132, and a degree of safety calculation unit 133. The degree of safety is a degree that indicates safety of the anonymized data, and is calculated for each set of values of the anonymization parameters.

The anonymization apparatus 100 includes n (n is an integer more than or equal to 2) number of attack attempting units 130. To differentiate the n number of attack attempting units 130, each attack attempting unit 130 will be written as attack attempting unit 130_1, . . . , and attack attempting unit 130_n. The attack unit 131, the re-identification data storage unit 132, and the degree of safety calculation unit 133 that attack attempting unit 130_i (i is an integer, 1≤i≤n) includes will be respectively written as attack unit 131_i, re-identification data storage unit 132_i, and degree of safety calculation unit 133_i. Attack unit 131_i, re-identification data storage unit 132_i, and degree of safety calculation unit 133_i correspond to each other.

In the following, attack attempting unit 130_1 will be described. Each of attack attempting unit 130_2, . . . , and attack attempting unit 130_n is a same as attack attempting unit 130_1.

The attack attempting unit 130 is configured in a way that the attack attempting unit 130 can respond to every re-identification attack that is imaginable. The re-identification attack is an attack that tries to re-identify at least a part of the personal data from the anonymized data. There can also be a case where at least a part of the personal data cannot be re-identified by a re-identification attack according to an intention of the re-identification attack. The re-identification attack imaginable is typically an attack that uses a re-identification attack algorithm that is known by the provider and is an attack that the provider may reach to think of as having a possibility of the recipient executing. In a case where a certain re-identification attack algorithm is an algorithm that includes a plurality of other re-identification attack algorithms, the attack attempting unit 130 may use only the certain re-identification attack algorithm, and does not have to use the plurality of other re-identification attack algorithms. That is, the attack attempting unit 130 does not have to use every re-identification attack algorithm that corresponds to each of the re-identification attacks imaginable.

Attack unit 131_1 is an element that performs a re-identification attack on the anonymized data to generate re-identification data. The re-identification data is information that is generated as a result of executing the re-identification attack on the anonymized data. In a case where attack unit 131_1 failed the re-identification attack, the re-identification data is information that cannot specify an individual. In a case where attack unit 131_1 succeeded in the re-identification attack, the re-identification data is information that can specify an individual.

Attack unit 131_1, . . . , and attack unit 131_n perform re-identification attacks using re-identification attack algorithms that differ from each other.

A plurality of attack units 131 generate a plurality of pieces of re-identification data by performing re-identification attacks on the anonymized data using a plurality of re-identification attack algorithms. Each of the plurality of pieces of re-identification data is information that corresponds to the anonymized data, and is information that corresponds to each of the plurality of re-identification attack algorithms. Each of the plurality of attack units 131 generates any one of the plurality of pieces of re-identification data using any one of the plurality of re-identification attack algorithms that differs from each other.

The number of each of the plurality of re-identification attack algorithms, the plurality of pieces of re-identification data, and the plurality of attack units 131 is a same. Each of the plurality of re-identification attack algorithms differs from each other and corresponds to any one of the plurality of pieces of re-identification data that differs from each other. The plurality of re-identification attack algorithms may include a plurality of algorithms of a certain type or a family. The plurality of pieces of re-identification data may include a plurality of certain pieces of re-identification data in duplicate. There is also a case where every value of the plurality of pieces of re-identification data that correspond to each of the plurality of re-identification attack algorithms that differs from each other becomes a same.

Re-identification data storage unit 132_1 is an element that stores the re-identification data that attack unit 131_1 generated.

Degree of safety calculation unit 133_1 is an element that calculates a degree of safety of a re-identification attack on the anonymized data using the re-identification data and the personal data that attack unit 131_1 generated.

The degree of safety calculation unit 133 indicates a degree of safety of the anonymized data using the personal data and each of the plurality of pieces of re-identification data, and calculates a plurality of degrees of safety that correspond to each of the plurality of pieces of re-identification data. Each of the plurality of pieces of re-identification data corresponds to any one of the plurality of degrees of safety that differs from each other.

A parameter adjustment unit 140 is an element that adjusts a value of the anonymization parameter using the degree of safety that each degree of safety calculation unit 133 calculated.

The parameter adjustment unit 140 may adjust a value of a parameter by applying optimization technology. Here, as a specific example, the parameter adjustment unit 140 uses a technique that follows a gradient descent method. In the present example, the parameter adjustment unit 140 adjusts the anonymization parameter by loop processing.

The parameter adjustment unit 140 adjusts the anonymization parameter in a case where at least one of the plurality of degrees of safety does not satisfy a degree of safety standard. The degree of safety standard indicates a standard of safety of the anonymized data. In a case where all of the plurality of degrees of safety satisfy the degree of safety standard, a certain level of safety for the anonymized data is guaranteed. There may be more than one degree of safety standards such that a different value is set for each re-identification attack algorithm and the like, or the degree of safety standard may be a value that is dependent on a requirement and the like.

A parameter storage unit 141 is an element that stores the value of the anonymization parameter.

An output unit 150 is an element that outputs anonymized data that is decided on finally.

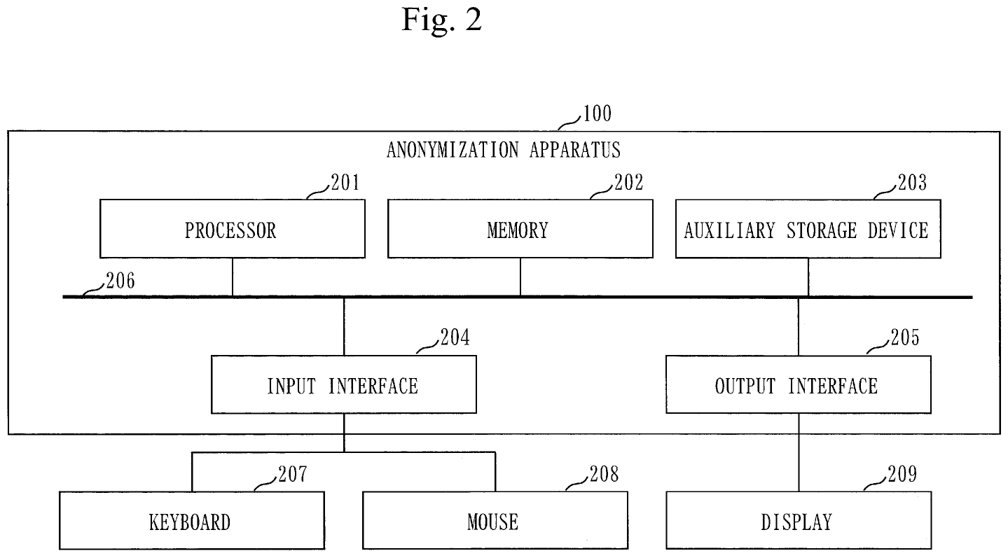

FIG. 2 illustrates an example of a hardware configuration for enabling each function of the anonymization apparatus 100. The anonymization apparatus 100 is formed of a computer. The anonymization apparatus 100 may be formed of a plurality of computers.

The computer is configured of a processor 201, a memory 202, an auxiliary storage device 203, an input interface 204, and an output interface 205. These elements are connected to each other through a bus 206.

The processor 201 is an IC (Integrated Circuit) that performs various types of calculation processes, and controls hardware that the computer includes. The processor 201 is, as a specific example, a CPU (Central Processing Unit), a DSP (Digital Signal Processor), or a GPU (Graphics Processing Unit).

The anonymization apparatus 100 may include a plurality of processors that replace the processor 201. The plurality of processors share roles of the processor 201.

The memory 202 can temporarily store data necessary for calculation, and is typically a volatile storage device. The memory 202 is also called a main storage device or a main memory. The memory 202 is, as a specific example, a RAM (Random Access Memory). The data stored in the memory 202 is saved in the auxiliary storage device 203 as necessary. The data means electronic data unless otherwise noted.

The auxiliary storage device 203 can store data, and is typically a non-volatile storage device. The auxiliary storage device 203 is, as a specific example, a ROM (Read Only Memory), an HDD (Hard Disk Drive), or a flash memory. The data stored in the auxiliary storage device 203 is loaded into the memory 202 as necessary.

The memory 202 and the auxiliary storage device 203 may be configured integrally.

The input interface 204 is a site for inputting to the anonymization apparatus 100, and can be connected with an input device. The input device is used for a person in charge, who is not illustrated, belonging to the provider to input the personal data, to give instructions to the anonymization apparatus 100, and the like. The input devices are, as specific examples, a keyboard 207 and a mouse 208.

The output interface 205 is a site for outputting from the anonymization apparatus 100, and can be connected with an output device. The output device displays a result of calculation, a status of the anonymization apparatus 100, and the like. The output device is, as a specific example, a display 209.

Here, correspondence between FIG. 1 and FIG. 2 will be described.

The input unit 110 corresponds to the input interface 204.

The personal data storage unit 111, the anonymized data storage unit 121, the re-identification data storage unit 132, and the parameter storage unit 141 correspond to the auxiliary storage device 203.

The anonymization unit 120, the attack unit 131, the degree of safety calculation unit 133, and the parameter adjustment unit 140 correspond to the processor 201 and the memory 202.

The output unit 150 corresponds to the output interface 205.

FIG. 2 illustrates a most basic example of the hardware configuration of the anonymization apparatus 100. The anonymization apparatus 100 does not have to be in the configuration illustrated in FIG. 2.

As a specific example, an external storage medium may be connected to at least one of the input interface 204 and the output interface 205. The external storage medium is, as a specific example, a USB (Universal Serial Bus) flash drive.

As another specific example, the anonymization apparatus 100 may be connected to a different computer through a network cable by the network cable being connected to at least one of the input interface 204 and the output interface 205. The network cable is, as a specific example, a cable that supports Ethernet (registered trademark).

The auxiliary storage device 203 stores an anonymization program. The anonymization program is a program that makes the computer enable functions of each unit that the anonymization apparatus 100 includes. The anonymization program may be formed of a plurality of files. The anonymization program is loaded into the memory 202, and executed by the processor 201. The functions of each unit that the anonymization apparatus 100 includes are enabled by software.

Data used at a time of executing the anonymization program, data obtained by executing the anonymization program, and the like are suitably stored in a storage device. Each unit of the anonymization apparatus 100 suitably uses the storage device. The storage device is, as a specific example, formed of at least one of the memory 202, the auxiliary storage device 203, a register in the processor 201, and a cache memory in the processor 201. There is a case where data and information have an equal meaning. The storage device may be a device that is independent of the computer.

Each of functions of the memory 202 and functions of the auxiliary storage device 203 may be enabled by a different storage device.

The anonymization program may be recorded in a computer-readable non-volatile recording medium. The non-volatile recording medium is, as a specific example, an optical disc or a flash memory. The anonymization program may be provided as a program product.

### Description of Operation

An operation procedure of the anonymization apparatus 100 is equivalent to the anonymization method. A program that enables operation of the anonymization apparatus 100 is equivalent to the anonymization program.

First, a summary of the operation of the anonymization apparatus 100 will be described, and then, details of each operation of the anonymization apparatus 100 will be described. In the description below, a description of a process of the attack attempting unit 130 is a description of a process of each of the n number of attack attempting units 130, and a description of a process of each element of the attack attempting unit 130 is a description of a process of each of each element of the n number of attack attempting units 130.

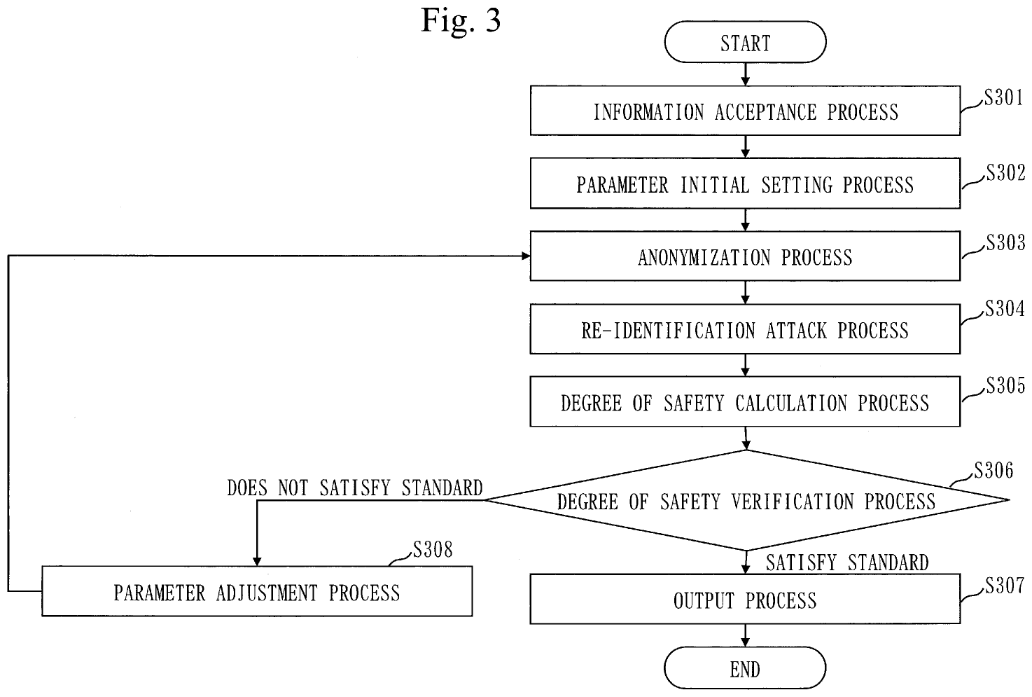

FIG. 3 is a flowchart that represents an example of a processing procedure of the anonymization apparatus 100 in the present embodiment. The processing procedure is a procedure in which the anonymization apparatus 100 generates the anonymized data. An example of the processing procedure will be described using the present drawing.

(Step S301: Information Acceptance Process)

The input unit 110 accepts input of the personal data that is a processing target, and stores in the personal data storage unit 111, the personal data that is accepted. In the following, in the description of the present flowchart, the personal data means the personal data that the input unit 110 accepted in the present step unless otherwise noted.

A method to input the personal data may be any method as long as the method is the method in which the anonymization apparatus 100 can read the personal data. The method is, as a specific example, a method to use a keyboard, a method to use a medium, or a method to input information through a network.

(Step S302: Parameter Initial Setting Process)

The parameter adjustment unit 140 generates an initial parameter by performing initial setting for the anonymization parameter. The initial parameter is the anonymization parameter on which the initial setting has been carried out. The parameter adjustment unit 140 stores in the parameter storage unit 141, the initial parameter as the anonymization parameter.

(Step S303: Anonymization Process)

The anonymization unit 120 generates the anonymized data from the personal data using the anonymization parameter, and stores in the anonymized data storage unit 121, the anonymized data that is generated.

The anonymization unit 120 may generate the anonymized data from latest anonymized data. The latest anonymized data is anonymized data that is latest among the anonymized data that the anonymization apparatus 100 generated. In the following, in the description of the present flowchart, the anonymized data means the anonymized data generated in the present step unless otherwise noted.

(Step S304: Re-Identification Attack Process)

The attack unit 131 generates the re-identification data by performing a re-identification attack on the anonymized data, and stores in the re-identification data storage unit 132, the re-identification data that is generated. In the following, in the description of the present flowchart, the re-identification data means the re-identification data that is generated in the present step unless otherwise noted.

(Step S305: Degree of Safety Calculation Process)

The degree of safety calculation unit 133 calculates a degree of safety using the re-identification data and the personal data.

Step S304 and step S305 are processes that each of then number of attack attempting units 130 executes. The n number of attack attempting units 130 may execute step S304 and step S305 in parallel.

(Step S306: Degree of Safety Verification Process)

The parameter adjustment unit 140 verifies whether or not a value of each degree of safety that is calculated satisfies the degree of safety standard.

In a case where all of the degrees of safety that are calculated satisfy the degree of safety standard, the anonymization apparatus 100 proceeds to step S307. In a case other than the above, the anonymization apparatus 100 proceeds to step S308.

(Step S307: Output Process)

The output unit 150 outputs the anonymized data. The anonymization apparatus 100 ends the processes of the present flowchart.

(Step S308: Parameter Adjustment Process)

The parameter adjustment unit 140 generates a new parameter by adjusting the anonymization parameter. The new parameter is the anonymization parameter that is adjusted by the parameter adjustment unit 140. The parameter adjustment unit 140 stores in the parameter storage unit 141, the new parameter as the anonymization parameter. The parameter adjustment unit 140 may update the anonymization parameter.

The anonymization apparatus 100 returns to step S303.

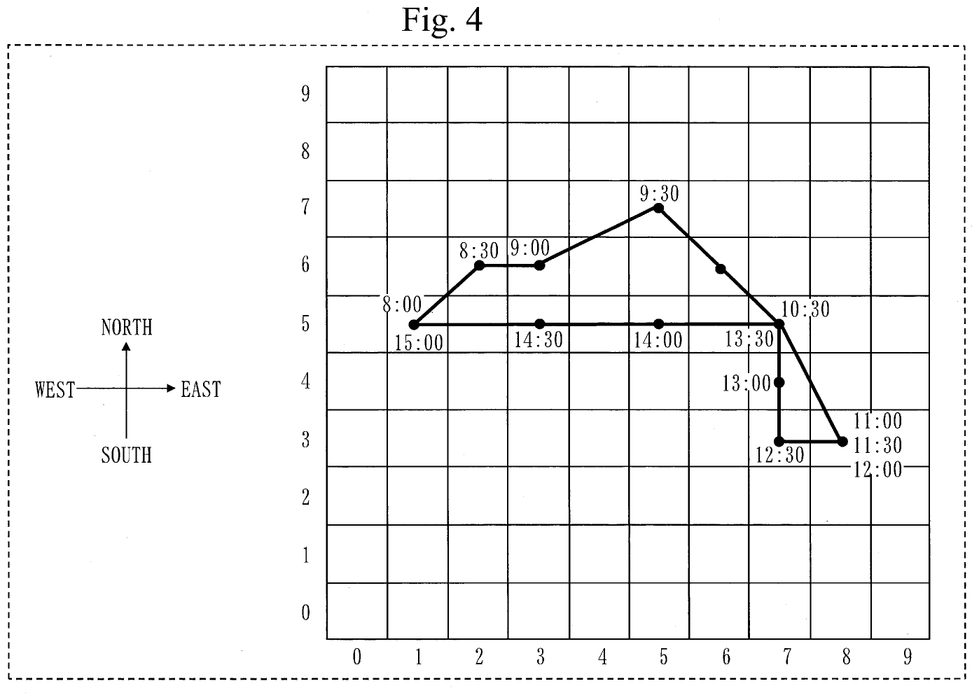

A specific example of each step of the processing procedure of the anonymization apparatus 100 will be described using FIG. 4 to FIG. 9.

FIG. 4 is a diagram visualizing an example of the personal data that is inputted in step S301. The personal data that corresponds to FIG. 4 indicates time series data of an individual, especially travel history of an individual. The time series data of an individual is data in which each of one or more individuals and time series data corresponding to each of the one or more individuals are linked.

Here, a way of looking at FIG. 4 will be described. In the present drawing, a total of 100 squares that are of an area divided into 10 sections in an east-west direction and 10 sections in a north-south direction are prepared. The squares are introduced to virtually divide an area. Each of the sections of the 10 sections is indicated by a number from 0 to 9. In the present drawing, information that indicates in which square of the 100 squares individual T stayed in intervals of 30 minutes is indicated. In a center of the square that individual T stayed in at a time of day, a black round dot is indicated. Numbers displayed around a black dot are times of day when individual T stayed in the square with the black dot being displayed. In a case where a square in which individual T stayed at a time of day and a square in which individual T stayed 30 minutes after the time of day differ, dots that are indicated in these two squares are linked. In the present description, there is a case where a dot means a place in which an individual stayed.

When squares in the east-west direction are represented using variable x, and squares in the north-south direction are represented using variable y, it can be seen that individual T, for example, stayed inside a square of (x, y)=(1, 5) at 8:00. And, it can be seen that individual T travelled to a position of (2, 6) at 8:30. It can be seen that individual T stayed at a position of (8, 3) from 11:00 to 12:00. FIG. 4, in the manner described, is a diagram that visualized personal data that indicates position information on individual T every 30 minutes.

For convenience of description, FIG. 4 illustrates only positions of where individual T stayed during a day. The anonymization apparatus 100 may have as the processing target, personal data that includes positions of where many individuals stayed extending over a plurality of days.

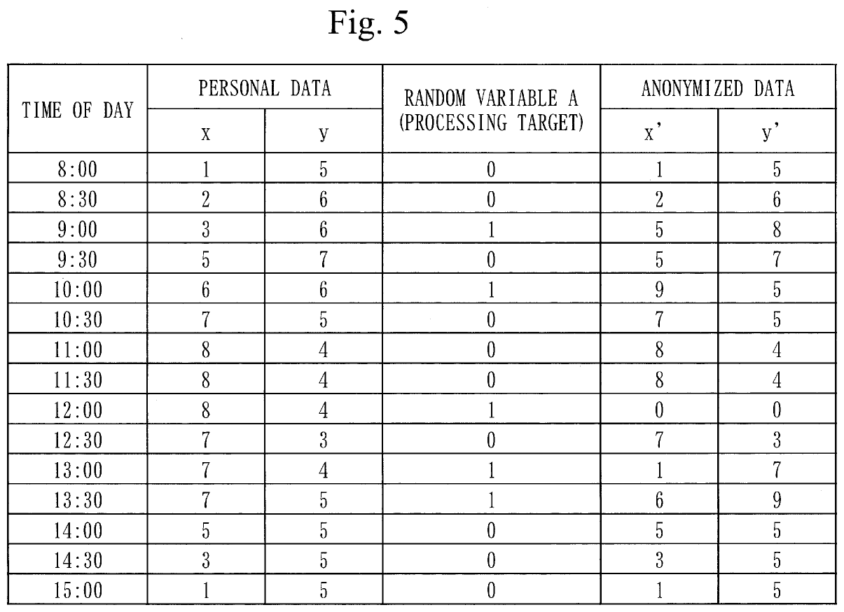

FIG. 5 is a table illustrating the personal data corresponding to FIG. 4, an example of anonymized data corresponding to the personal data, and the like. Each row in FIG. 5 corresponds to a dot indicating a position of individual T. Columns other than “Personal Data” in FIG. 5 will be described later.

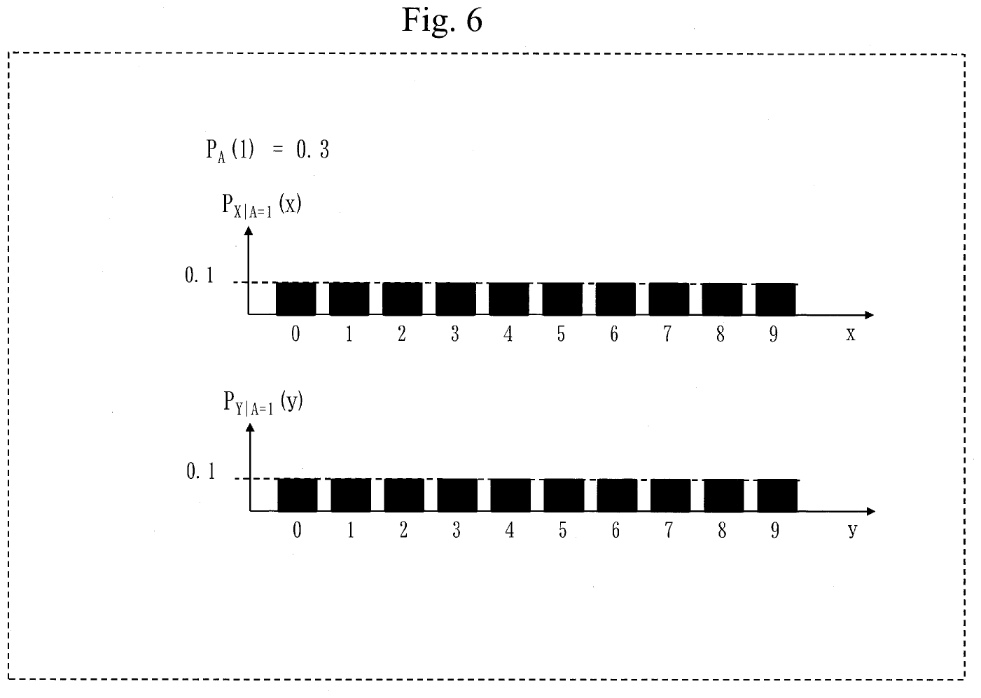

FIG. 6 is a diagram illustrating an example of the initial parameters in the parameter adjustment unit 140 set in step S302.

FIG. 6 corresponds to a case where the anonymization unit 120 adopts as the anonymization method, a method to select each of the dots that indicate positions based on a prescribed probability as the processing target, and rewrite each value of x and y of each of the dots selected to an appropriate value based on a probability.

In FIG. 6, three types, P_{A} (1), P_{X|A}=1 (x), and P_{Y|A=1} (y), are illustrated as the initial parameters. Here, each initial parameter will be described.

Let random variable A be a random variable that represents whether to select (A=1) or not to select (A=0) a dot that indicates a position as the processing target. Here, parameter P_{A} (1) represents a probability of a value of random variable A being 1, that is, a probability of selecting a dot that indicates a position as a dot of the processing target. In the example of FIG. 6, parameter P_{A} (1)=0.3 represents that a probability of selecting a dot that indicates a position as the processing target is 0.3.

Px_{|A=1} (x), when A=1, that is, in a case where a dot is selected as a dot of the processing target, represents a conditional probability mass function of a value of x after the dot is processed. In the example of FIG. 6, parameter P_{X|A=1} (x) is uniformly 0.1 regardless of the value of x.

Similarly, P_{Y|A=1} (y), when A=1, that is, in a case where a dot is selected as a dot of the processing target, represents a conditional probability mass function of a value of y after the dot is processed. In the example of FIG. 6, parameter P_{Y|A=1} (y) is uniformly 0.1 regardless of the value of y.

Various methods can be considered as a setting method of the initial parameter.

As a specific example, a case will be considered where the recipient gives as a requirement for the anonymized data, anonymized data that is close to original personal data. In the present case, the setting method where parameter P_{A} (1) is set to a small value such as 0.01 and the like, P_{X|A=1} (x) is set to Px (x), that is, a value of a probability distribution of x of entire original personal data, and P_{Y|A=1} (y) is set to P_{Y} (y), that is, a value of a probability distribution of y of the entire original personal data can be considered. To avoid the value of the anonymization parameter being what is called a local optimal solution, the parameter adjustment unit 140 may adopt a method where each of values of P_{A} (1), P_{X|A=1} (x), and P_{Y|A=1} (y) is set to a random value.

The parameter adjustment unit 140 may adopt various methods as an initial parameter setting method according to the initial parameter, the requirement of the anonymized data, or to conditions of nature and the like of the anonymization method.

The description will return again to FIG. 5. A column of “Anonymized Data” indicates an example of the anonymized data generated in step S303. As illustrated in the present drawing, with regard to a dot of which a value in a “Random Variable A” column is 1, that is, a dot that is selected as the processing target, “Anonymized Data” x′ and y′, values after being processed according to the values of P_{X|A=1} (x) and P_{Y|A=1} (y), are generated for each dot. On the other hand, with regard to a dot of which a value in the “Random Variable A” column is 0, that is, a dot that is not selected as the processing target, x′ and y′, values after being processed, are x and y respectively, x and y being values of an original dot. The original dot is a position indicated in the “Personal Data” column. The values after being processed are positions indicated in “Anonymized Data”.

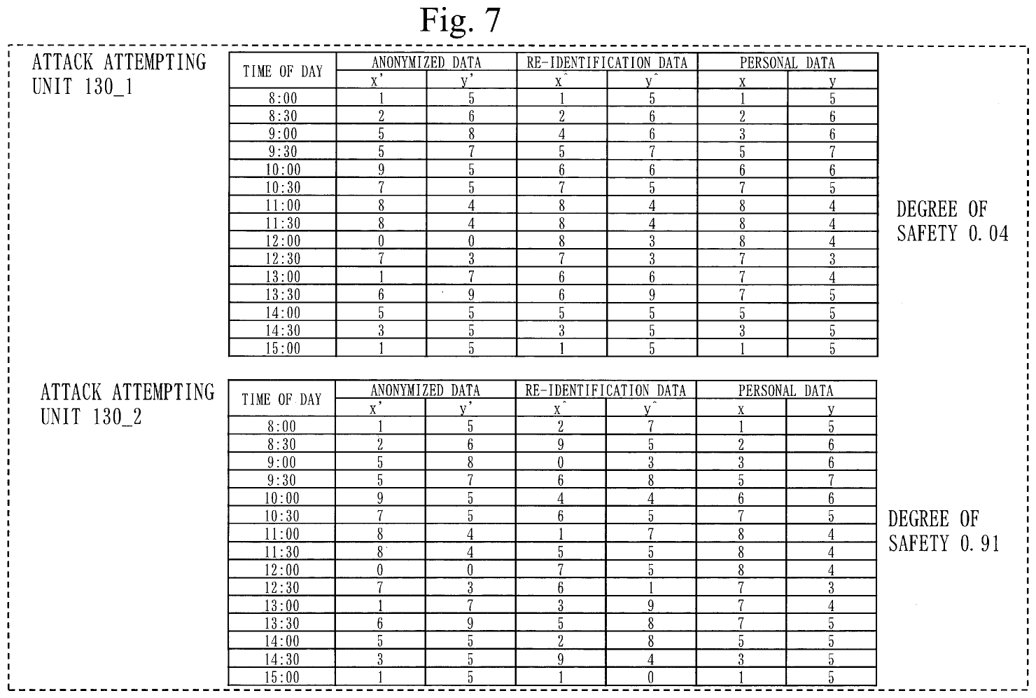

FIG. 7 illustrates an example of processing results of each of step S304 and step S305. The present drawing illustrates an example of a case where the attack attempting unit 130 uses two, that is, two types of re-identification attack algorithms. In the following, the re-identification attack and the degree of safety will be described using the present drawing.

A re-identification attack algorithm of attack attempting unit 130_1 will be described.

First, attack unit 131_1 calculates for each time of day, a distance between a dot at each time of day and a dot at a previous time of day, that is, a travel distance per unit time in each time of day.

Next, with regard to a dot that is creating a long travel distance, attack unit 131_1 calculates the re-identification data by carrying out linear interpolation using values of each dot at a time of day before and after the time of day corresponding to the dot.

A re-identification attack algorithm of attack attempting unit 130_2 will be described.

First, with regard to each of x′ and y′ of “Anonymized Data”, attack unit 131_2 calculates probability distributions P_{X′}(x′) and P_{Y′}(y′).

Next, attack unit 131_2 randomly selects re-identification data x\hat{ } and y\hat{ } according to the probability distribution calculated. Attack unit 131_2 may generate the re-identification data in any way.

A column of “Re-identification Data” in each table in FIG. 7 indicates examples of the re-identification data calculated by these re-identification attack algorithms. A column of “Personal Data” in each table is a same as the column of “Personal Data” of FIG. 5. “Personal Data” is used to calculate the degree of safety.

In FIG. 7, the degree of safety is defined by Euclidean distance between a dot of the re-identification data and a dot of the personal data at each time of day. Here, in a case where the degree of safety is 0, the degree of safety being 0 represents that the re-identification data completely matches the personal data. In a case where the degree of safety is 1, the degree of safety being 1 represents that the re-identification data and the personal data are independent of each other. In the way described, each attack attempting unit 130 calculates the degree of safety.

When a dot of personal data at time of day t is represented as (xₜ, yₜ) and a dot of the re-identification data is represented as (xₜ\hat{ }, yₜ\hat{ }), Euclidean distance between the dot of the re-identification data and the dot of the personal data at time of day t can be indicated as in [Math 1]. Here, the degree of safety is, as a specific example, defined by [Math 2]. In the present example, in a case where the degree of safety exceeds 1, the degree of safety can be changed to 1.

$$Euclidean Distance := \sqrt{{( {x}_{t} - {\hat{x}}_{t} )}^{2} + {( {y}_{t} - {\hat{y}}_{t} )}^{2}} \qquad [ Math 1 ]$$

$$Degree of Safety := \frac{{\sum }_{t = 8 : 00}^{15 : 00} \sqrt{{( {x}_{t} - {\hat{x}}_{t} )}^{2} + {( {y}_{t} - {\hat{y}}_{t} )}^{2}}}{1000} \qquad [ Math 2 ]$$

Needless to say, various techniques can be considered for a calculation technique of the re-identification attack algorithms and the degree of safety. As another example of the re-identification attack algorithm, an algorithm that generates the re-identification data from the anonymized data by predicting that the anonymized data as a whole is processed by translating the personal data, and translating the anonymized data towards a direction opposite from the direction that the personal data is translated for a same distance as the distance that the personal data is translated, can technique that defines the degree of safety by Manhattan distance between the dot of the re-identification data and the dot of the personal data at each time of day can be given.

The degree of safety standard is, as a specific example, “values of all of the degrees of safety are more than or equal to 0.3 or the number of repetitions exceeds one million times.” All of the degrees of safety mean all of the degrees of safety that the n number of degree of safety calculation units 133 calculated. The number of repetitions means, in a case where the parameter adjustment unit 140 uses the optimization technology, the number of iterations in the gradient descent method and the like. The number of repetitions is, as a specific example, the number of times that the loop illustrated in FIG. 3 is executed. The examples illustrated in FIG. 7 do not satisfy the present standard.

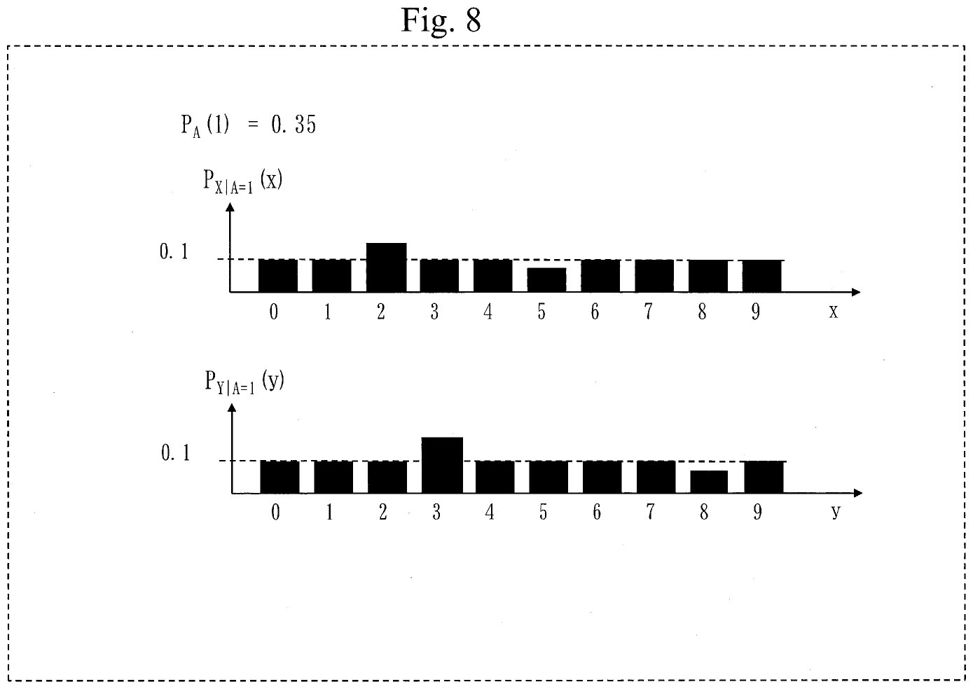

FIG. 8 illustrates an example of new parameters. FIG. 8 corresponds to a case where the parameter adjustment unit 140 adopts as an adjustment technique of a parameter, a technique in which P_{A} (1) is increased and some of the values of each of P_{X|A=1} (x) and P_{Y|A=1} (y), as targets, are increased or decreased.

Needless to say, various techniques can be considered for the adjustment technique of a parameter. As another example of the adjustment technique of a parameter, a technique that uses a steepest descent method or a stochastic gradient descent method in a machine learning field can be given.

The anonymization apparatus 100 returns to step S303 after step S308, and performs anonymization again on the personal data.

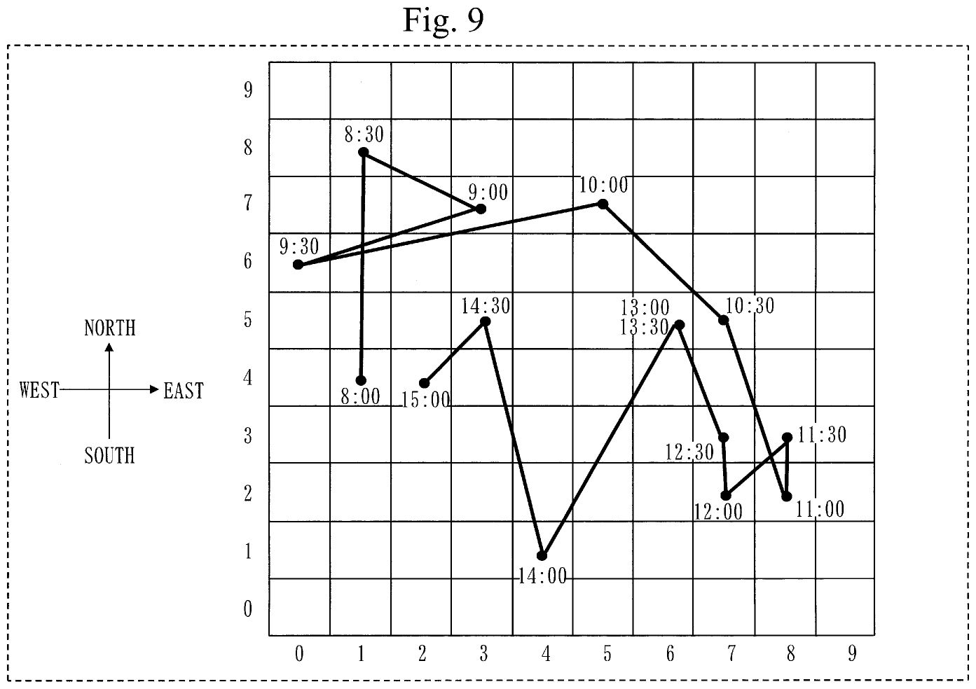

FIG. 9 is a diagram that visualized examples of the anonymized data that the output unit 150 outputs in step S307. A way of looking at the present drawing is a same as the way of looking at FIG. 4.

### Description of Effect of Embodiment 1

As described above, according to the present embodiment, the anonymization apparatus 100 can respond to every re-identification attack that is imaginable. Specifically, the attack unit 131 generates re-identification data that correspond to each re-identification attack that is imaginable, the degree of safety calculation unit 133 calculates degrees of safety that correspond to each re-identification attack that is imaginable, and the parameter adjustment unit 140 adjusts an anonymization parameter in a way that the degree of safety satisfies a prescribed standard.

Thus, the anonymization apparatus 100 according to the present embodiment can generate anonymized data of which prescribed safety is guaranteed for every re-identification attack that is imaginable.

### Other Configurations

<Variation 1>

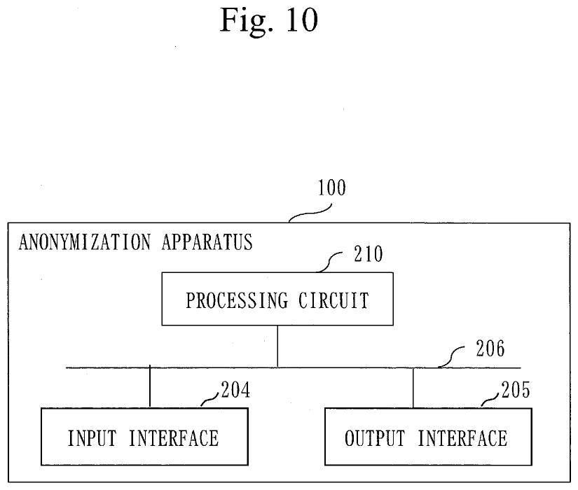

FIG. 10 illustrates an example of a hardware configuration of an anonymization apparatus 100 according to the present variation.

The anonymization apparatus 100 includes, as illustrated in the present drawing, a processing circuit 210 instead of at least one of the processor 201, the memory 202, and the auxiliary storage device 203.

The processing circuit 210 is hardware that enables at least some of each unit that the anonymization apparatus 100 includes.

The processing circuit 210 may be dedicated hardware and may be a processor that executes a program stored in the memory 202.

In a case where the processing circuit 210 is dedicated hardware, the processing circuit 210 is, as a specific example, a single circuit, a composite circuit, a programmed processor, a parallel programmed processor, an ASIC (ASIC is Application Specific Integrated Circuit), an FPGA (Field Programmable Gate Array), or a combination of these.

The anonymization apparatus 100 may include a plurality of processing circuits that replace the processing circuit 210. The plurality of processing circuits share roles of the processing circuit 210.

In the anonymization apparatus 100, a part of functions may be enabled by dedicated hardware and the rest of the functions may be enabled by software or firmware.

The processing circuit 210 is, as a specific example, enabled by hardware, software, firmware, or a combination of these.

The processor 201, the memory 202, the auxiliary storage device 203, and the processing circuit 210 are generically called “processing circuitry”. That is, functions of each functional element of the anonymization apparatus 100 are enabled by the processing circuitry.

With regard to anonymization apparatuses 100 according to other embodiments, configurations may be a same as the configuration of the present variation.

### Embodiment 2

In the following, mainly differing points from the embodiment described above will be described while referring to the drawings.

The present embodiment is useful especially in a case where the personal data is attribute data of an individual. The attribute data is data that indicates a property of an individual in various types of categories. The attribute data is, as a specific example, grades that an individual got in school. The attribute data of an individual is data in which each of one or more individuals and attribute data corresponding to each of the one or more individuals are linked.

### Description of Configuration

A functional configuration according to the present embodiment is a same as a functional configuration in Embodiment 1.

### Description of Operation

Since a summary of operation of an anonymization apparatus 100 according to the present embodiment is a same as the summary of the operation of the anonymization apparatus 100 in Embodiment 1, a description will be omitted. In the following, details of the operation of the anonymization apparatus 100 will be described.

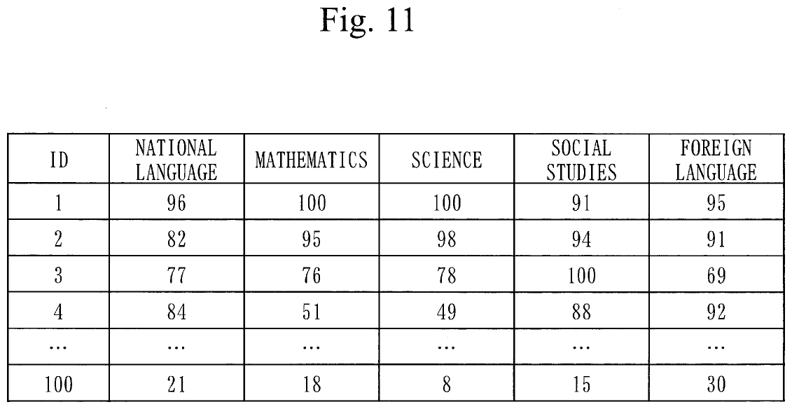

FIG. 11 illustrates an example of some pieces of the personal data inputted in step S301. The personal data in FIG. 11 is the attribute data of an individual, especially, the grades that an individual got in school.

In FIG. 11, for each of one hundred individuals to which an ID (identifier) of any one of 1 to 100 is assigned, points from 0 to 100 are given as a grade for each of five subjects, national language, mathematics, science, social studies, and foreign language.

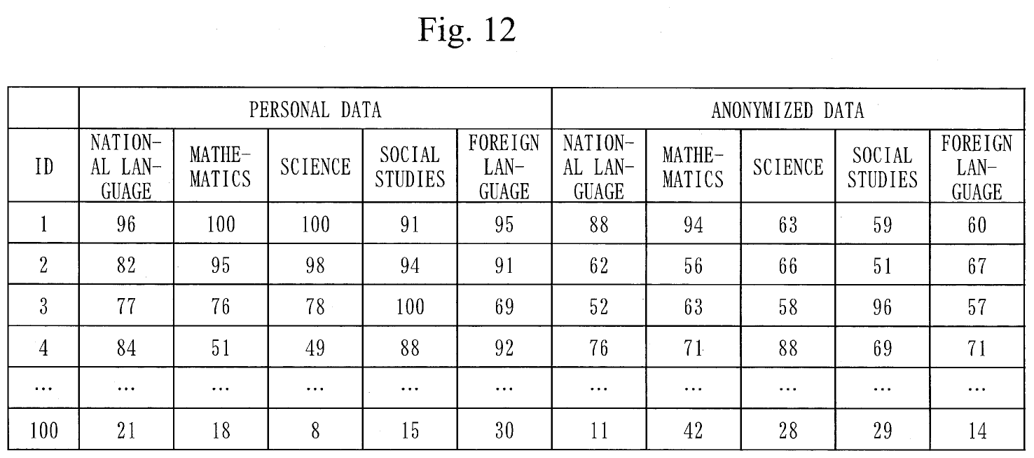

FIG. 12 illustrates an example of the personal data and anonymized data. The anonymized data in the present example is the anonymized data that is generated in step S303 using the personal data in the present example. An anonymization technique in the preset example is a technique that adds a random number to each grade value.

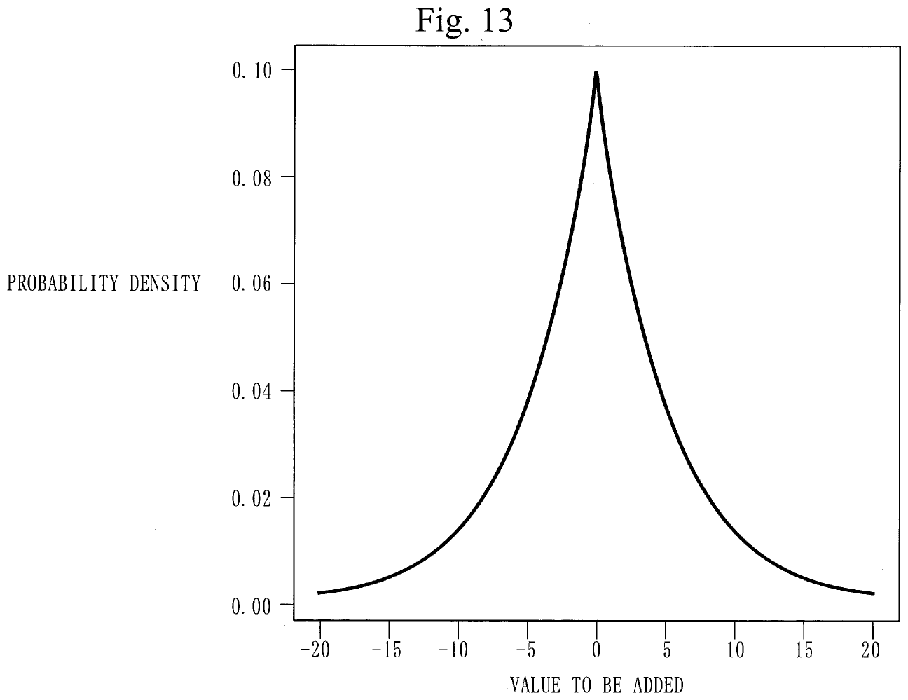

FIG. 13 illustrates a probability density function corresponding to an example of an initial parameter. The present example is an example in which a random number according to a Laplace distribution is simulated to be used as the random number to be added to each grade value. Parameters in the present example are the two, mean μ=0 and variance σ\hat{ }2=50.

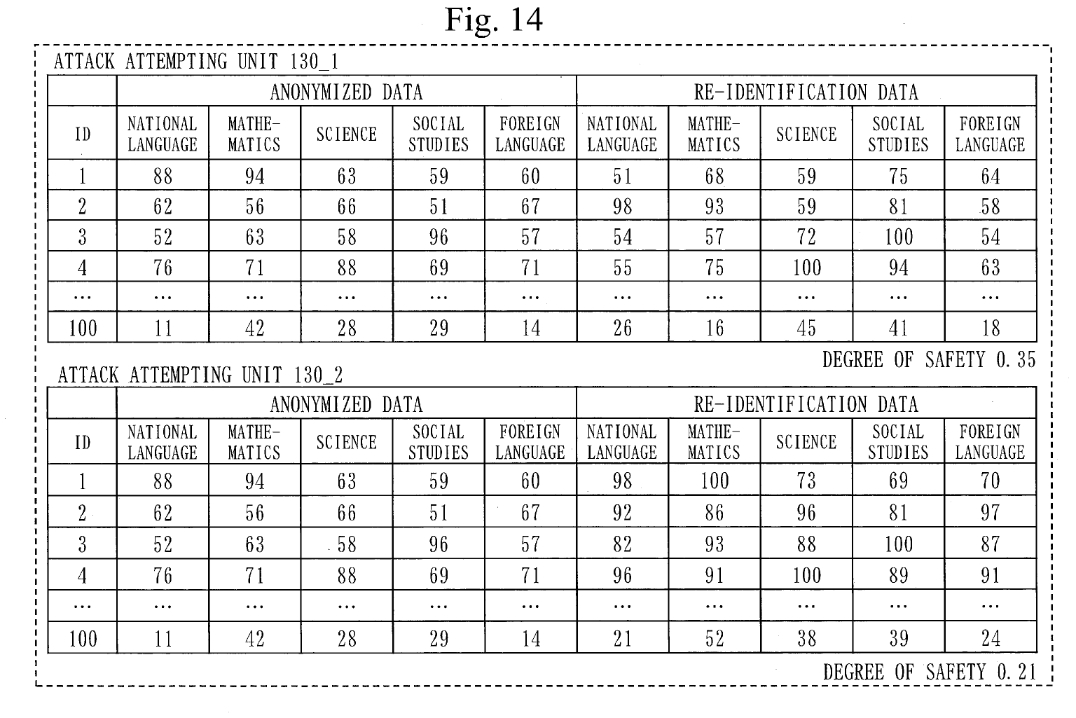

FIG. 14 is a diagram illustrating an example of the anonymized data, re-identification data, and degrees of safety. The re-identification data is the re-identification data calculated in step S304. The degree of safety is the degree of safety calculated in step S305.

FIG. 14 corresponds to a case where the anonymization apparatus 100 includes two attack attempting units 130.

A re-identification attack algorithm of attack attempting unit 130_1 is set as an algorithm that calculates a value according to a normal distribution based on the mean and the variance of all grade values of five people before and after an individual as a grade value of each individual.

A re-identification attack algorithm of attack attempting unit 130_2 is set as an algorithm that adds a constant value to each individual.

A calculation technique of the degree of safety is set as a technique that defines the degree of safety by Manhattan distance between a grade value of each piece of re-identification data and a grade value of each piece of personal data.

### Description of Effect of Embodiment 2

As described above, the anonymization apparatus 100according to the present embodiment can obtain a same effect as the effect of Embodiment 1 even when the personal data is the attribute data of an individual.

### Embodiment 3

In the following, mainly differing points from the embodiments described above will be described while referring to the drawings.

An anonymization apparatus 100 according to the present embodiment includes a plurality of anonymization units 120.

### Description of Configuration

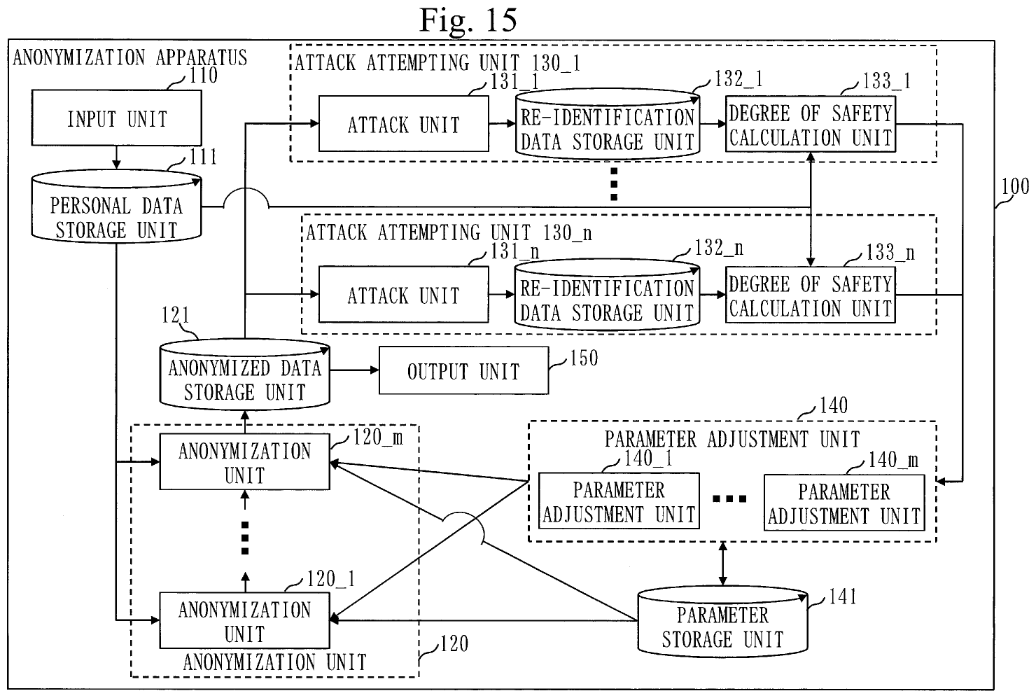

FIG. 15 illustrates an example of a functional configuration of the anonymization apparatus 100 according to the present embodiment.

In the present embodiment, since the functional configuration of the anonymization apparatus 100 is a same as the functional configuration of the anonymization apparatus 100 according to Embodiment 1 other than the anonymization unit 120 and a parameter adjustment unit 140, a description will be omitted.

The anonymization apparatus 100 according to the present embodiment includes m (m is an integer more than or equal to 2) number of anonymization units 120. Each of the m number of anonymization units 120 will be written as anonymization unit 120_1, . . . , and anonymization unit 120_m. An anonymization algorithm that each of the m number of anonymization units 120 uses may differ from each other or a part may overlap with another.

The anonymization apparatus 100 may include the plurality of anonymization units 120 as a plurality of anonymization units. Each of the plurality of anonymization units 120 uses one anonymization algorithm that differs from each other. The plurality of anonymization units 120 generate the anonymized data in cooperation with each other.

An output from anonymization unit 120_1 is inputted to anonymization unit 120_2 that is not illustrated. An output from anonymization unit 120_2 is inputted to anonymization unit 120_3 that is not illustrated. Similarly, an output from anonymization unit 120_(m-1) that is not illustrated is inputted to anonymization unit 120_m.

FIG. 15 illustrates an example in which a connection form of the m number of anonymization units 120 is a serial connection. The connection form of the m number of anonymization units 120 contributes to the plurality of anonymization units 120 cooperating with each other.

The anonymization apparatus 100 according to the present embodiment includes m number of parameter adjustment units 140. The anonymization apparatus 100 may include the plurality of parameter adjustment units 140 as a plurality of parameter adjustment units. The number of each of the plurality of anonymization units 120 and the plurality of parameter adjustment units 140 is a same. Each of the plurality of parameter adjustment units 140 adjusts an anonymization parameter that corresponds to any one of the plurality of anonymization units 120 that differs from each other.

Each of the m number of parameter adjustment units 140 will be written as parameter adjustment unit 140_1, . . . , and parameter adjustment unit 140_m. Parameter adjustment unit 140_j (j is an integer, 1≤j≤m) corresponds to anonymization unit 120_j. That is, parameter adjustment unit 140_j adjusts a parameter that anonymization unit 120_j uses.

### Description of Operation

Since a summary of operation of the anonymization apparatus 100 according to the present embodiment is a same as the summary of the operation of the anonymization apparatus 100 of Embodiment 1, a description will be omitted. Since details of each step other than the details of step S303 are a same as the details of each step in at least one of Embodiment 1 and Embodiment 2 except that each of the m number of parameter adjustment units 140 executes a process corresponding to each of the m number of anonymization units 120, a description will be omitted.

Step S303 in the present embodiment will be described using the personal data illustrated in FIG. 4.

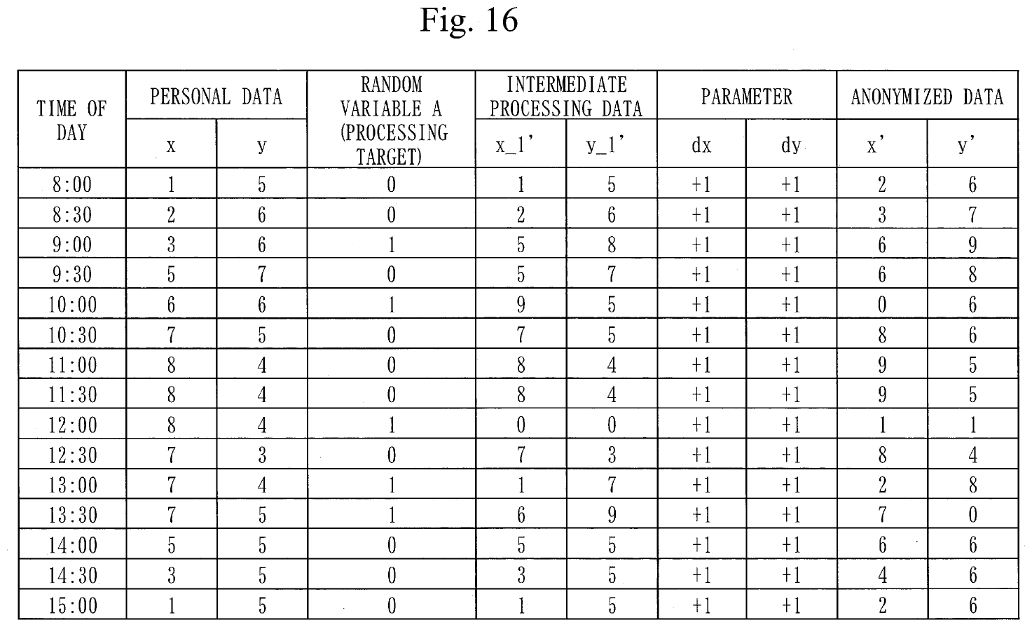

FIG. 16 illustrates an example of intermediate processing data, anonymized data, and the like in the present embodiment. Here, an example of a case where there are two anonymization units 120, that is, the anonymization apparatus 100 uses two types of anonymization algorithms, is illustrated.

In FIG. 16, each column of “Time of Day”, “Personal Data”, “Random Variable A (Processing Target)”, and “Intermediate Processing Data” is a same as the columns in Embodiment 1. “Intermediate Processing Data” is, however, “Anonymized Data” in Embodiment 1. That is, anonymization unit 120_1 in the present embodiment is a same as the anonymization unit 120 according to Embodiment 1. Here, an output from the anonymization unit 120 according to Embodiment 1 is called “intermediate processing data” instead of “anonymized data”.

A column of “Parameter” represents parameters that anonymization unit 120_2 uses. A column of “Anonymized Data” indicates outputs of anonymization unit 120_2, and represents the anonymized data in the present embodiment. The anonymized data is generated by processing the intermediate processing data.

In FIG. 16, an example of anonymization is illustrated in which, as an anonymization technique of anonymization unit 120_2, translation based on [Mathematical Formula 1] is performed on all of the dots of the intermediate processing data (x_y′,y_1′) with (dx, dy)=(1, 1).

(x′, y′)=((x_1′+dx) mod 10, (y_1′+dy) mod 10) [Mathematical Formula 1]

According to the description described above and FIG. 16, the anonymization algorithm of anonymization unit 120_1 is an algorithm that replaces some dots with random dots.

The anonymization algorithm of anonymization unit 120_2 is an algorithm that translates each dot. That is, anonymization unit 120_1 and anonymization unit 120_2 use different algorithms.

### Description of Effect of Embodiment 3

As described above, the anonymization apparatus 100 according to the present embodiment generates the anonymized data by combining a plurality of anonymization algorithms by the plurality of anonymization units 120. Consequently, in a situation of an actual attack, to deduce the anonymization algorithm from the anonymized data that the anonymization apparatus 100 according to the present embodiment generated is relatively difficult.

Thus, the anonymization apparatus 100 according to the present embodiment can create anonymized data that is more resistant to an attack.

### Other Configurations

<Variation 2>

The connection form of the m number of anonymization units 120 may be a parallel connection, and may be a form that is a combination of a serial connection and a parallel connection.

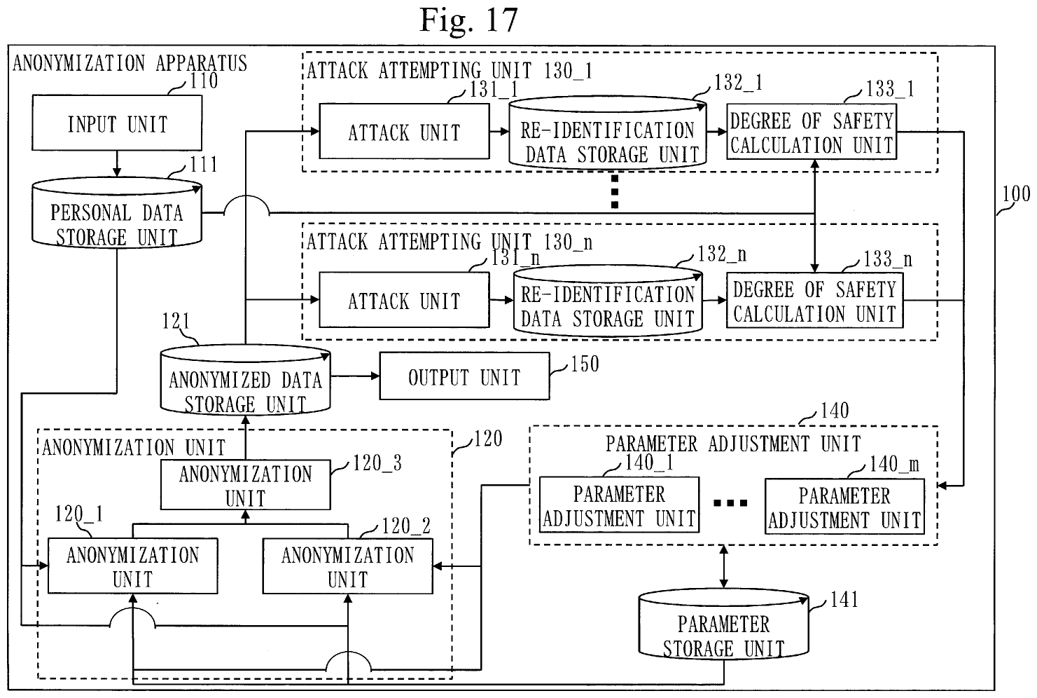

FIG. 17 illustrates a specific example in which three anonymization units 120 are connected in a connection form where the serial connection and the parallel connection are combined.

In the present example, anonymization unit 120_1 generates intermediate processing data (x_1′, y_1′) using [Mathematical Formula 2]. Anonymization unit 120_2 generates intermediate processing data (x_2′, y_2′) using [Mathematical Formula 3]. Let (dx, dy)=(1, 1) in [Mathematical Formula 2] and [Mathematical Formula 3]. Anonymization unit 120_3 generates anonymized data (x′, y′) using [Mathematical Formula 4].

(x_1′, y_1′)=((x+dx) mod 10,(y+dy) mod 10) [Mathematical Formula 2]

(x_2′, y_2′)=((x+dx) mod 10,(y+dy) mod 10) [Mathematical Formula 3]

(x′, y′)=((x_1′+x_2′)/2,(y_2′+y_2′)/2) [Mathematical Formula 4]

### Embodiment 4

In the following, mainly differing points from the embodiments described above will be described while referring to the drawings.

An anonymization apparatus 100 according to the present embodiment is an apparatus whose purpose is to respond when an attacker attacks anonymized data using auxiliary data. The auxiliary data is information other than the anonymized data. An attack unit 131 according to the present embodiment attacks using the auxiliary data in addition to the anonymized data, differing from the attack unit 131 according to Embodiment 1 to Embodiment 3.

### Description of Configuration

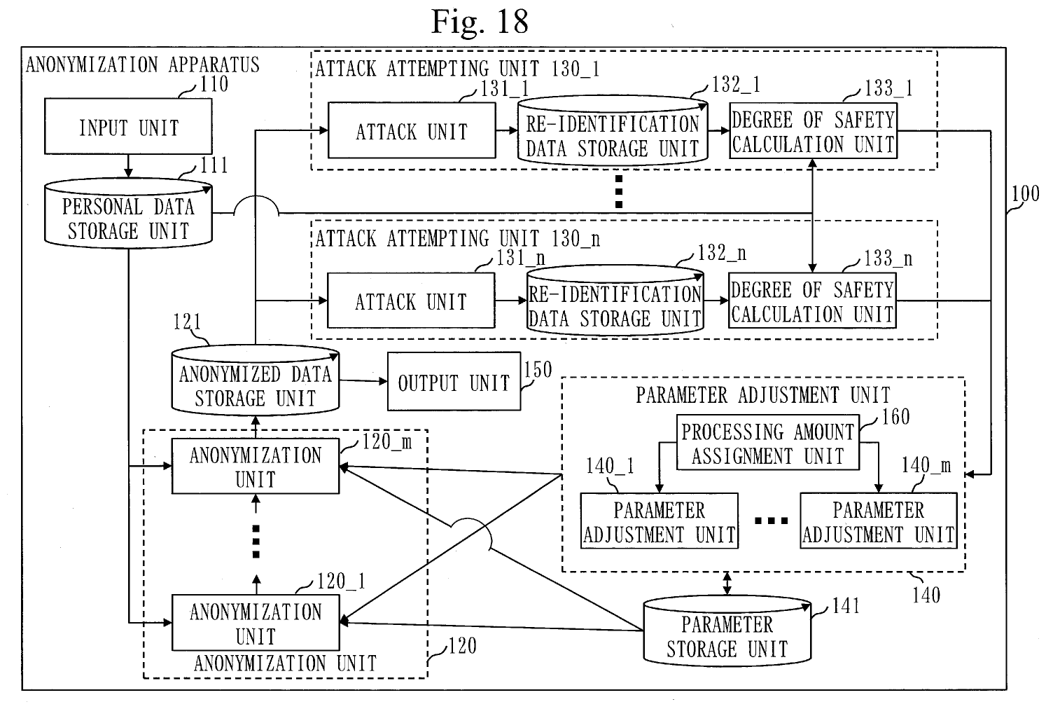

FIG. 18 illustrates an example of a functional configuration of the anonymization apparatus 100 of the present embodiment. Since the functional configuration of the anonymization apparatus 100 is a same as the functional configuration of the anonymization apparatus 100 in Embodiment 3 other than the parameter adjustment unit 140, a description of the functional configuration of the anonymization apparatus 100 other than the parameter adjustment unit 140 will be omitted.

The parameter adjustment unit 140 according to the present embodiment includes as an internal configuration, a processing amount assignment unit 160 in addition to an internal configuration of the parameter adjustment unit 140 according to Embodiment 3.

The processing amount assignment unit 160 finds a processing amount assignment value. The processing amount assignment value indicates an amount that each of the plurality of anonymization units 120 processes the personal data, and is used for assigning the amount that each anonymization unit 120 processes the personal data.

Each of a plurality of parameter adjustment units 140 adjusts according to the processing amount assignment value, an anonymization parameter that corresponds to any one of the plurality of anonymization units 120 that differs from each other.

### Description of Operation

A summary of operation of the anonymization apparatus 100 is a same as the summary of the operation of the anonymization apparatus 100 according to Embodiment 1. Consequently, a description of the summary of the operation will be omitted.

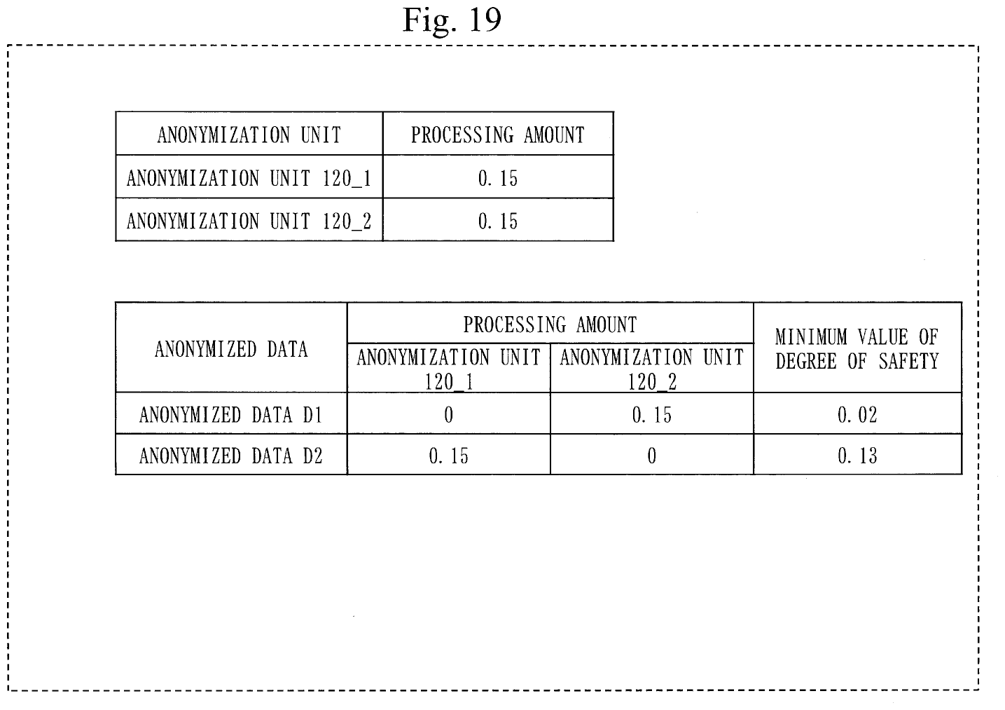

In the following, in the description of the operation, the personal data illustrated in FIG. 4 will be used. A specific example of each step of a processing procedure of the anonymization apparatus 100 will be described using FIG. 19.

FIG. 19 illustrates an example of processing amount parameter tables that the processing amount assignment unit 160 in the present embodiment uses. The processing amount assignment unit 160 defines a processing amount using the processing amount parameter table. The processing amount parameter table is also called a parameter table for processing amount assignment.

In the following, a specific example of each step of the processing procedure of the anonymization apparatus 100 in the present embodiment will be described. Since step S301 is a same as at least any one of step S301 in Embodiment 1 to Embodiment 3, a description will be omitted.

In step S302, as illustrated in a column of “Processing Amount” of a table at a top of FIG. 19, the processing amount assignment unit 160 sets a processing amount of each anonymization unit 120. In the following, in the description of each step, the processing amount means the processing amount that the processing amount assignment unit 160 set in the present step.

Operation of each parameter adjustment unit 140 is a same as the operation of the parameter adjustment unit 140 of Embodiment 1 except that the anonymization parameter is set such that the anonymization parameter is within a range of the processing amount.

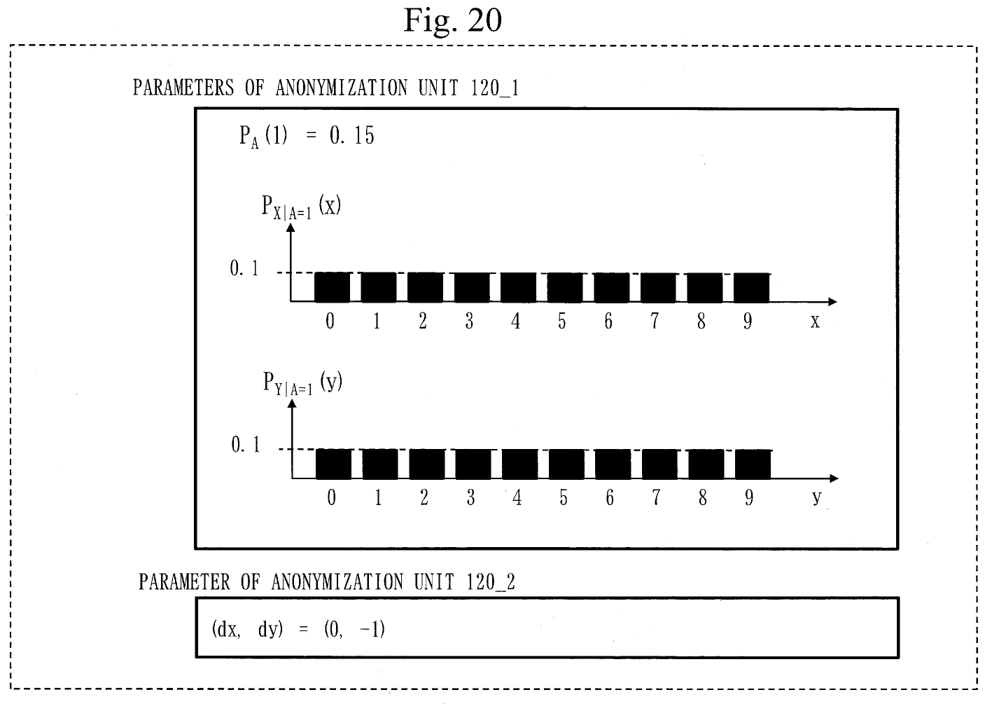

FIG. 20 illustrates an example of initial parameters of each anonymization unit 120 in the present embodiment. A value of parameter P_{A} (1) is 0.15.

Parameter P_{A} (1) represents a probability of selecting a dot that indicates a position as the processing target, and is a parameter that directly affects the processing amount. Consequently, parameter P_{A} (1) is set according to the processing amount.

Parameter (dx, dy)=(0, −1) of anonymization unit 120_2 is also set according to the processing amount.

In step S303, the anonymization unit 120 generates the anonymized data from the personal data using the initial parameter, and stores the anonymized data that is generated in the anonymized data storage unit 121. At this time, the anonymization unit 120 deliberately generates anonymized data for a case where some of the processing amounts are set to 0 for the attack unit 131 to take an attacker attacking using auxiliary data other than the anonymized data in addition to the anonymized data into consideration. The operation of the present step achieves an aim of the present embodiment.

For example, in a table at a bottom of FIG. 19, anonymized data D1 is generated by setting a processing amount of anonymization unit 120_1 to 0 and a processing amount of anonymization unit 120_2 to 0.15. Anonymized data D2 is generated by setting the processing amount of anonymization unit 120_1 to 0.15 and the processing amount of anonymization unit 120_2 to 0. That is, in the present embodiment, the anonymization unit 120 generates a plurality of pieces of anonymized data.

In FIG. 19, an example in which one of the processing amounts is set to 0 is illustrated. The processing amount assignment unit 160, however, does not necessarily have to set the processing amount to 0, and any value can be given as the processing amount.

The attack attempting unit 130 calculates the degree of safety through step S304 and step S305. Here, the attack attempting unit 130 calculates n number of degrees of safety using results from attack attempting unit 130_1 to attack attempting unit 130_n for each of the plurality of pieces of anonymized data, and sets a minimum value as the degree of safety of the anonymized data.

In step S306, the parameter adjustment unit 140 compares the value of each degree of safety that is calculated with the degree of safety standard, and verifies whether or not the value of each degree of safety satisfies the degree of safety standard.

In a case where all of each degree of safety satisfies the degree of safety standard, the anonymization apparatus 100, after generating the anonymized data based on the processing amount assignment value in a top table of FIG. 19, the output unit 150 outputs the anonymized data in step S307, and ends the process.

In a case other than the above, the anonymization apparatus 100 proceeds to step S308. In step S308, the parameter adjustment unit 140 performs a parameter adjustment such as changing the processing amount assignment value and the like, and stores a new parameter that is adjusted in the parameter storage unit 141. Changing of the processing amount assignment value is performed by the processing amount assignment unit 160. Then, the anonymization apparatus 100 returns to step S303 and performs anonymization again on the personal data or on the anonymized data at the point in time.

### Description of Effect of Embodiment 4

As described above, the anonymization apparatus 100 according to the present embodiment includes the processing amount assignment unit 160 that assigns the processing amount. The anonymization unit 120 can create the plurality of pieces of anonymized data according to the processing amount taking also an attacker attacking the anonymized data using the auxiliary data other than the anonymized data into consideration.

Thus, the anonymization apparatus 100 according to the present embodiment can respond to an attack that uses the auxiliary data.

### Other Embodiments

A free combination of each embodiment described above, or a variation of any element of each embodiment, or omitting of any element in each embodiment is possible.

The embodiments are not to be limited to the embodiments indicated in Embodiment 1 to 4, and various changes are possible to be made as necessary. Procedures described using the flowchart and the like may suitably be changed.

### REFERENCE SIGNS LIST

100: anonymization apparatus; 110: input unit; 111: personal data storage unit; 120: anonymization unit; 121: anonymized data storage unit; 130: attack attempting unit; 131: attack unit; 132: re-identification data storage unit; 133: degree of safety calculation unit; 140: parameter adjustment unit; 141: parameter storage unit; 150: output unit; 160: processing amount assignment unit; 201: processor; 202: memory; 203: auxiliary storage device; 204: input interface; 205: output interface; 206: bus; 207: keyboard; 208: mouse; 209: display; 210: processing circuit; D1, D2: anonymized data.

1. An anonymization apparatus comprising:
processing circuitry to:
generate anonymized data, the anonymized data being personal data that is anonymized, by anonymizing the personal data using an anonymization algorithm, the anonymization algorithm being an algorithm that anonymizes the personal data and that uses an anonymization parameter,
generate a plurality of pieces of re-identification data, the re-identification data being information that corresponds to the anonymized data and that corresponds to each of a plurality of re-identification attack algorithms, by performing a re-identification attack on the anonymized data using the plurality of re-identification attack algorithms that execute the re-identification attack that tries to re-identify at least a part of the personal data from the anonymized data,
calculate a plurality of degrees of safety that indicate safety of the anonymized data using the personal data and each of the plurality of pieces of re-identification data, and that correspond to each of the plurality of pieces of re-identification data, and
adjust the anonymization parameter in a case where at least one of the plurality of degrees of safety does not satisfy a degree of safety standard that indicates a standard of safety of the anonymized data, wherein
the number of each of the plurality of re-identification attack algorithms and the plurality of pieces of re-identification data is a same,
each of the plurality of re-identification attack algorithms differs from each other and corresponds to any one of the plurality of pieces of re-identification data that differs from each other,
the processing circuitry generates any one of the plurality of pieces of re-identification data using any one of the plurality of re-identification attack algorithms that differs from each other, and
each of the plurality of pieces of re-identification data corresponds to any one of the plurality of degrees of safety that differs from each other.

2. The anonymization apparatus according to claim 1, wherein
the number of each of a plurality of anonymization algorithms and a plurality of anonymization parameters is a same,
the processing circuitry adjusts an anonymization parameter that corresponds to any one of the plurality of anonymization algorithms that differs from each other,
the processing circuitry uses the plurality of anonymization algorithms, and
the plurality of anonymization algorithms generate the anonymized data in cooperation with each other.

3. The anonymization apparatus according to claim 2, wherein
the processing circuitry
finds a processing amount assignment value that indicates an amount that each of the plurality of anonymization algorithms processes the personal data, and
adjusts according to the processing amount assignment value, an anonymization parameter that corresponds to any one of the plurality of anonymization algorithms that differs from each other.

4. The anonymization apparatus according to claim 1, wherein
the processing circuitry
anonymizes the personal data according to a property of the personal data.

5. The anonymization apparatus according to claim 2, wherein
the processing circuitry
anonymizes the personal data according to a property of the personal data.

6. The anonymization apparatus according to claim 3, wherein
the processing circuitry
anonymizes the personal data according to a property of the personal data.

7. The anonymization apparatus according to claim 1, wherein
the personal data is time series data of an individual.

8. The anonymization apparatus according to claim 2, wherein
the personal data is time series data of an individual.

9. The anonymization apparatus according to claim 3, wherein
the personal data is time series data of an individual.

10. The anonymization apparatus according to claim 4, wherein
the personal data is time series data of an individual.

11. The anonymization apparatus according to claim 5, wherein
the personal data is time series data of an individual.

12. The anonymization apparatus according to claim 6, wherein
the personal data is time series data of an individual.

13. The anonymization apparatus according to claim 1, wherein
the personal data is attribute data of an individual.

14. The anonymization apparatus according to claim 2, wherein
the personal data is attribute data of an individual.

15. The anonymization apparatus according to claim 3, wherein
the personal data is attribute data of an individual.

16. The anonymization apparatus according to claim 4, wherein
the personal data is attribute data of an individual.

17. The anonymization apparatus according to claim 5, wherein
the personal data is attribute data of an individual.

18. The anonymization apparatus according to claim 6, wherein
the personal data is attribute data of an individual.

19. An anonymization method comprising:
generating anonymized data, the anonymized data being personal data that is anonymized, by anonymizing the personal data using an anonymization algorithm, the anonymization algorithm being an algorithm that anonymizes the personal data and that uses an anonymization parameter, by an anonymization unit;
generating a plurality of pieces of re-identification data, the re-identification data being information that corresponds to the anonymized data and that corresponds to each of a plurality of re-identification attack algorithms, by performing a re-identification attack on the anonymized data using the plurality of re-identification attack algorithms that execute the re-identification attack that tries to re-identify at least a part of the personal data from the anonymized data, by a plurality of attack units;
calculating a plurality of degrees of safety that indicate safety of the anonymized data using the personal data and each of the plurality of pieces of re-identification data, and that correspond to each of the plurality of pieces of re-identification data, by a degree of safety calculation unit; and
adjusting the anonymization parameter in a case where at least one of the plurality of degrees of safety does not satisfy a degree of safety standard that indicates a standard of safety of the anonymized data, by a parameter adjustment unit, wherein
the number of each of the plurality of re-identification attack algorithms, the plurality of pieces of re-identification data, and the plurality of attack units is a same,
each of the plurality of re-identification attack algorithms differs from each other and corresponds to any one of the plurality of pieces of re-identification data that differs from each other,
each of the plurality of attack units generates any one of the plurality of pieces of re-identification data using any one of the plurality of re-identification attack algorithms that differs from each other, and
each of the plurality of pieces of re-identification data corresponds to any one of the plurality of degrees of safety that differs from each other.

20. A non-transitory computer readable medium storing an anonymization program causing a computer to:
generate anonymized data, the anonymized data being personal data that is anonymized, by anonymizing the personal data using an anonymization algorithm, the anonymization algorithm being an algorithm that anonymizes the personal data and that uses an anonymization parameter;
generate a plurality of pieces of re-identification data, the re-identification data being information that corresponds to the anonymized data and that corresponds to each of a plurality of re-identification attack algorithms, by performing a re-identification attack on the anonymized data using the plurality of re-identification attack algorithms that execute the re-identification attack that tries to re-identify at least a part of the personal data from the anonymized data;
calculate a plurality of degrees of safety that indicate safety of the anonymized data using the personal data and each of the plurality of pieces of re-identification data, and that correspond to each of the plurality of pieces of re-identification data; and
adjust the anonymization parameter in a case where at least one of the plurality of degrees of safety does not satisfy a degree of safety standard that indicates a standard of safety of the anonymized data, wherein
the number of each of the plurality of re-identification attack algorithms and the plurality of pieces of re-identification data is a same,
each of the plurality of re-identification attack algorithms differs from each other and corresponds to any one of the plurality of pieces of re-identification data that differs from each other,
the computer is caused to generate any one of the plurality of pieces of re-identification data using any one of the plurality of re-identification attack algorithms that differs from each other, and
each of the plurality of pieces of re-identification data corresponds to any one of the plurality of degrees of safety that differs from each other.
